(19) United States
(12) Patent Application Publication
(10) Pub. No.: US 2006/0176374 A1
(43) Pub. Date: Aug. 10, 2006

(54) SYSTEM AND METHOD FOR PROVIDING HYBRID AUDIO/VIDEO SYSTEM

(76) Inventor: Robert Oklejas, Monroe, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 11/275,960

(22) Filed: Feb. 7, 2006

Related U.S. Application Data
(60) Provisional application No. 60/650,674, filed on Feb. 7, 2005.

(51) Int. Cl. H04N 5/232; H04N 7/00

(52) U.S. Cl. 348/211.8; 348/211.3; 348/118; 348/211.11

(57) ABSTRACT

A television entertainment system that combines the visual imagery of television entertainment and transmission with the audio of radio entertainment and transmission to create a new synthesis system for therapeutic benefit designated as Hybrid Radio Television. Each segment (video/audio) of the system can be viewed or heard/listened to on its own, however, it is designed to be viewed and heard/listened to as an integrated whole, as selected by a viewer.

### RELATED APPLICATIONS

The present invention is related to, and claims priority to, U.S. Provisional Patent Application Ser. No. 60/650,674, filed Feb. 7, 2005, which is hereby incorporated by reference.

### FIELD OF THE INVENTION

The present invention relates to a hybrid audio/video system.

### BACKGROUND OF THE INVENTION AND ADVANTAGES

In Enerchi Health, a web based health information service, recently it was stated that “People generally feel that they live cluttered, hectic, overwhelming lives; between work, family, and friends, or any of the dozens of things that fill our days and tax our body and mind, rarely do we take even a small part of our waking life entirely for ourselves, apart from unhealthy ‘escapist’ kinds of relaxation like TV that don't allow the mind to settle down. The almost permanent state of stimulation and stress inevitably has dire consequences for both mental and physical health, from higher blood pressure to compromised immune systems, leaving us vulnerable to any number of conditions. Making a priority of taking “time out” every day to simply withdraw from the whole mess can be a big step toward improving health.”

This new concept or format in television entertainment has as its primary goal the positive therapeutic effects of “time out” that would enhance mental and physical health. This therapeutic television system stands in stark contrast to the current frantic programming that is the norm in TV today. Frantic programming seeks to draw the viewer to ever narrower field of interests, but more intensely focused programming. The result is that there are dozens of entire networks devoted 24 hours per day, seven days per week to a single subject; i.e., The Food Network, Tennis Network, Speed, History Channel, Court TV, etc. Far from producing a mental ‘time out”, current programming adds gasoline to the fire of stress and information overload.

### SUMMARY OF THE INVENTION

In one aspect of the present invention, a hybrid audio and video system for providing video and/or audio to a display at a remote location in response to control signals received from a user is provided. The system includes at least one camera, a microphone, a source of a second video feed, and a control node. The at least one camera is located at a first location and provides a first video feed of a subject at the first location. The microphone is located at the first location and provides an audio feed of the first location. The control node is located at a central location and is coupled to the at least one camera, the microphone, and the second video source. The control node receives the control signals and provides a user video/audio feed to the display at the remote location based on the first video feed, the audio feed and/or the second video feed as a function of the control signals.

### BRIEF DESCRIPTION OF THE DRAWINGS

FIG. 1 shows a diagram of one embodiment of the present invention as described below.

### DETAILED DESCRIPTION OF THE PREFERRED EMBODIMENTS

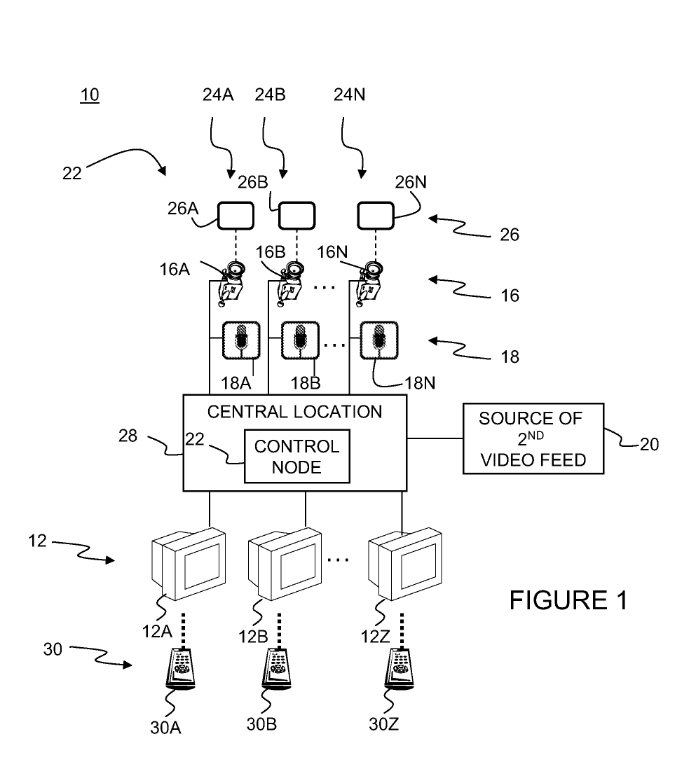

With reference to FIG. 1, and in operation, the present invention provides a hybrid audio and video system 10 for providing video and/or audio to a display 12 at a remote location 14 in response to control signals received from a user. The system 10 includes at least one camera 16, at least one microphone 18, a source of a second video feed 20, and a control node 20.

The at least one camera 16 is located at a respective location 24 and provides a first video feed of a subject 26 at the respective location 22. The microphone 16 may also be located at the location 24 for providing an audio feed of the location 24, but also maybe located at some other location. In the illustrated embodiment, a plurality of cameras 16, 16B, . . . , 16N (three of which are shown) and a plurality of microphones 18A, 18B, . . . , 18N are located at a plurality of respective locations 24A, 24A, . . . , 24N for providing video/audio feeds of a respective plurality of subjects 26A, 26B, . . . , 26N.

The control node 20 may be located at a central location 28, such as a central studio. The control node 20 is coupled to the at least one camera 14, the microphone 16, and the second video source 18. The control node 20 receives the control signals and providing a user video/audio feed to the display 12 at the remote location based on the first video feed, the audio feed and/or the second video feed as a function of the control signals. The control node 20 receive the various video/audio feeds automatically and/or manually and mix them, resulting in various output feeds to be delivered to the monitor(s). The various video/audio feeds may be mixed according to predetermined rules and/or in response to the control signals received from the users.

In one aspect, the user or consumer controls operation of the system 10 including selecting between channels or feed, and/or creating custom feeds by combining various video and/or audio feeds to create the desired effect (see below). In one embodiment, the user controls the system 10 by sending control signals to the control node 22 via a control device 30, such as remote controllers 30A, 30B, 30Z. The remote controllers 30 allow the user to navigate through a series of menus (not shown) presented on the respective display 12A, 12B, 12Z.

In the illustrated embodiment, at least one of the cameras 22N is a remotely controlled High Definition Television system camera viewing the subject matter 26N. The microphone 18N is working in conjunction with the HDT system camera 16N to acquire the local environmental sounds that are being produced by the subject matter 26N. Such subject matter may deliberately selected for its aesthetically appealing qualities with an additional emphasis on scenes that produce a relaxation or calming effect on the human psyche. Such subject matter 26 may include, but not limited to a city skyline, a majestic landscape or seascape, etc. The subject matter 26 may be anywhere in the world and viewed at any time of day or night. The video and environmental audio output signal is transmitted by either digital satellite or digital cable to the control node or central studio 22 that is also controlling and receiving one or more other system cameras 16. At the central studio 22, the incoming video/audio signals are mixed and conditioned (local environmental sounds muted, eliminated in part or totally, or emphasized) with appropriate audio and/or video feeds from the source of 2^{nd} audio/video feeds 20. The audio/video feeds from the second source 20 may include, but not limited to musical selections and a possible optional human voice spoken by an “on-air” radio personality. The output signal now consisting of the system video and mixed audio is transmitted by digital cable and satellite or Internet to the user/consumer where it is displayed on a display 12. The display 12 may be any appropriate display including but not limited to a television, a computer, or a radio (for audio only).

Another embodiment of the hybrid audio/video system would substitute prerecorded video instead of live hybrid audio/video system camera outputs. Essentially the subject matter would remain the same or nearly so and subsequent processing would be the same or nearly the same as well. This version has a start up cost advantage over the multitude of HDT system cameras version.

Thus, a television entertainment format is disclosed that combines appropriate radio/musical entertainment formats with appropriate television visual imagery for the goal of an aesthetically pleasing and relaxing experience. It should be a therapeutic experience for the viewer. It includes a television entertainment system format whose purposeful design is to produce effortless calmness and a therapeutic “time out” in the viewer's daily life, and whose viewing does not interfere in other daily activities. The viewing experience is primarily a “live” viewing experience that creates the sense of the viewer being present at the locale. The television entertainment production method employs remote controlled cameras to capture the most aesthetically pleasing visuals available at any particular time. It may alternatively be a television program that uses prerecorded videotaped imagery. It may also be a television entertainment method that mixes music, environmental sounds, on-air voice and conversation with aesthetically pleasing visual presentations. It may alternatively be a commercial television entertainment format that allows use of audio/video, audio only and video only commercials or a television/radio format that mixes live locale sounds such as nature, surf, running water, rain, foghorn, or other soothing therapeutic sounds into the music or musical interludes.

The present invention is aimed at one or more of the problems set forth above.

### INDUSTRIAL APPLICABILITY

Within the last five years a number of technological developments in the electronic and television industry have been introduced on a national basis. These developments are:

1. Large Screen Projection and Plasma Television sets;

2. Digital Satellite and Cable Television; and

3. High Definition Television.

Large Screen television sets make possible movie like viewing of television programming. The large screen format delivers a life like or “you are there experience”

Both satellite and cable digital television transmission systems now allow the capacity to simultaneously transmit up to 1500 channels. The sheer number of channels has resulted in a frantic search for content to fill this huge capability. Yet, content demand has not been satisfied as hundreds of channels are unused, thus making it possible to deliver nontraditional niche programming. Digital transmission has also dramatically improved picture and sound quality, again adding to the possibility of a “you are there experience.”

High Definition Television systems deliver a picture quality that is indistinguishable from real viewing to add significantly in combination to a “you are there experience.”

The present invention creates a hybrid audio/video or Hybrid Radio Television (“HRT”) system 10 experience for the viewer at selected intervals chosen by the viewer for therapeutic and relaxation benefit again selected on the basis of an individual viewer or group of viewers.

HRT Technical Considerations—Two main technical tasks required by the hybrid audio/video system are content acquisition and delivery. An important aspect of the most appealing format is the “live” presentation. It has long been recognized that ‘live” television creates the most interest and emotional connection to the viewer that tape or film simply cannot deliver. For instance it has been noted that television coverage of the 9-11 terrorist attacks noted that viewers in real time (live) experienced the same physical effects (elevated heart rate, sweating, and agitation) and psychological effects (fear, anxiety) as the witnesses in New York City. The similar but opposite effect of live scenes of aesthetically pleasing and relaxing content produces therapeutic calming effects as if the viewer was at each of these pleasant locales. Cameras in a number of different locales can be controlled remotely from a central studio. Similar to coverage of a golf tournament in which the coverage constantly changes from hole to hole to keep up a rhythm of action, the hybrid audio/video system director will constantly seek out the most interesting, dramatic, and appealing shots from locale to locale, etc. The live coverage can be supplemented by prerecorded footage as needed, for instance as a particularly dramatic introduction to a new locale.

Sight and Sound—The camera work of the hybrid audio/video system will often focus on single scene for prolonged periods of time (as compared to conventional television). For instance, a sunset scene may be viewed without any camera motion for 30 minutes or more. For a lighthouse subject format, the television camera may not change the scene for hours at a time. In other scenes that offer a less focused subject than a sunset or lighthouse, for instance a major cityscape, the camera will often stay motionless on a scene for a few minutes, but then slowly pan in different directions. Scene shifts between different locales will be accomplished with deliberate slowness, with time intervals between different locales measured in minutes to tens of minutes.

For scenes involving ship watching, the camera can acquire the ship at a great distance (as it emerges over the horizon) with telephoto lenses and then follow the vessel as its image grows in size, until close ups of various parts of the ship are possible. This camera view can last for an hour or more. Information about the ship, such as type, registry, tonnage, propulsion, etc can be displayed at the edges of the screen. Similar data can also accompany land scenes, such as what city, island, mountain, and locale is being viewed.

Although an hybrid audio/video system entertainment places a large focus on radio (audio) format of music and “on-air personality” conversation, another dimension of sound can be added to the format by including appropriate sounds from the locale either between musical accompaniments or mixed with the music. These sounds can convey the additional impression of “you are there,” or enhance it. These sounds can be selected for there relaxation/therapeutic effects, sounds such as surf, running water, rain, bird songs, etc. Other sounds such as lighthouse fog horns, ship whistles, weather sounds of wind, thunder can add to the realism and authenticity of the video presentation.

“On-air personalities” will provide continuity and additional interest to the visual/audio signals by providing entertaining conversation, information, and the calming soothing effective of the human voice. Information about the visual or music selection or artist can also be offered. In addition, traditional radio services such as weather, traffic, and even news may be provided where hybrid audio/video system entertainment is provided on a local or regional basis.

The method that will achieve the goal of therapeutic television is to combine visual imagery conveyed by primarily live television broadcast that are esthetically pleasing (beautiful architecture, cityscapes, harborscapes, landscapes and seascapes), yet purposefully calming to the human psyche (no drama, comedy, adventure, or any other forms that are designed to engage the viewer), with voice and music (with similarity to music therapy) that are also designed for calmness and relaxation. The audio portion of the programming is much like radio in that it can stand on its own as an entertainment format. Likewise the visual imagery stands on its own, yet is connected to the audio to create a sense of beauty and tranquility. This relationship between a radio like format and the visuals of television is called a Hybrid Radio Television system or HRT system

To give a sense of the HRT system programming, it can be described as follows—you are viewing through a window a beautiful, interesting land/sea/city/harbor scene while listening to your favorite music or radio program. It is as if you lived in the most desired locations in the world—a South Pacific isle, Nob Hill in San Francisco, downtown Chicago, or the Canadian Rockies, when in fact you are watching these scenes in your own home on a large screen HDTV television (preferably but not necessarily). These scenes with the voice and/or music accompaniment are not imperative to watch. You can watch/listen as you choose. The HRT system does not, unlike conventional television programming, demand your attention. You will not have the frustration of missing some moment of dialogue or plot or action sequence because, although the scenes change (slowly), the effect of purposeful calmness and esthetic fulfillment remain constant. HRT system therapeutic television can be on during conversation, dinner, while you read or work. And that is by design, while the design intent of “demanding television” is to make it difficult to impossible to engage in any of the above. Even programs on relaxation therapy such as yoga or exercise programs still require you to focus and think about what is being presented. Some of those programs may be related to relaxation, while the HRT system actually is therapy and relaxation.

A number of the following (but certainly not limited to) specific system formats suggest themselves as appropriate for HRT system therapeutic television.

HRT Cityscapes and Harborscapes—This HRT system program format features the world's most spectacular city and harbor scenes—New York, San Francisco, Hong Kong, etc—spectacular skylines, building architecture, ships from the far corners of the world arriving and departing. Sunsets and sunrises on the Golden Gate, the Bosporus, Rio de Janeiro, are the visuals of the HRT system in this format. In Chicago, New York, or any other great city for that matter, the most sought after residences are luxury apartment/condominiums with a great view. Ten thousand dollars a month for rent is typical for these addresses. This is what cityscapes and harborscapes can deliver to a viewer anywhere in the world. All the while, appropriate music—cool jazz, easy listening, classics, soft rock, or contemporary pop is offered up by a deep melodious voiced “on-air” personality, or solely choreographed without any human voices interposed. One can enjoy hours, an hour, a few minutes, or any selected amount of time of detachment, relaxation and enjoyment watching sunset and nightfall in San Francisco, or watching ships or planes departing and arriving from world destinations. All of the scenes and music are beautiful and endlessly interesting, but none are imperative to watch. The HRT system will always be there, 24 hours per day, seven days per week, whenever the viewer wants it, which may be in real time or time shifted.

HRT Ship Channel—This HRT system format is closely related to cityscapes, but with an emphasis on ship watching. So in addition to the great port cities of the world, additional live cameras can cover ships transiting and locking through canals and waterways (Suez Canal, Well and, St. Lawrence, Sault St. Marie, Kiel, etc.). In the Great Lakes area, ship watching is a very popular pastime. Hundreds of thousands of people travel hundreds of miles to the lock system at Sault Ste. Marie, Mi or viewing locations at hotels and motels along the St. Claire River for this activity. The HRT system can bring an electronically enhanced ship watching experience to people thousands of miles from the nearest ocean or port, including the possibility of watching these scenes in real time or time shifted, as desired.

HRT Ships at Sea—Imagine the sense of relaxation the view from a river boat cruise can offer. With the ships at sea HRT system format, the viewer can float down the Mississippi, the Nile, the (Blue) Danube, the Rhine, the Volga, or any other of the world's great rivers flowing past the captivating countryside and cities of those far away and exotic locales. Or if he or she is in the mood for a less serene experience, the viewer can ride out a perfect storm on the North Atlantic or crash to the North Pole on a nuclear powered ice breaker. By placing television cameras on ships and cruise boats, the HRT system's ships at sea format can get you there as you watch the wake of your ship meet the horizon, accompanied by your favorite music.

HRT Tropical Paradise—In this HRT system format the viewer sees palm trees bending and swaying into the wind overlooking a full moonlit beach, while the sounds of the surf creates a soothing background for the musical accompaniment. This format should be one of the most powerful HRT system formats in achieving a therapeutic “time out.”

HRT Lighthouses—Lighthouse tourism and collectables is a major cottage industry in the US. Many have a mystical attraction to these sentinels of the sea and what better way to fulfill that yearning than to live by one courtesy of a large high definition HRT experience. HRT Lighthouses will be one of the formats where the camera scene can remain motionless for hours on end.

Simulcasting Regional and Local HRT—Because the HRT system is politically and culturally neutral, the potential scale of delivery is worldwide. The HRT system format though, also allows for local content, as the HRT system can easily incorporate local commercials as well as local content. For instance, a Great Lakes version of the HRT system can be simulcast with a radio format such as the locally produced portion of a popular Detroit radio station. Local radio personalities can use the visuals of the HRT system as a compliment to their topics of discussion. The simulcast can be delivered via local cable distributors.

Revenue and Commercials—The HRT system may be designed to be a basis for a profit making business. As such, ad revenue generating commercials may be integrated as a part of the programming. To maintain and even enhance the HRT system therapeutic television experience, commercials will follow guidelines of style and content that will reinforce the HRT system programming experience. Including, but not limited to:

1. Traditional audio and video content commercials;

2. Audio only—for instance the “on-air personality” can read a commercial while the visuals of the current HRT system locale are still playing. This an original development in TV commercials in which sound only conveys the commercial content while the “entertainment” video portion remains basically unchanged;

3. Visual only—a sponsor's company or corporate logo (for a time period of 15-30-60 minutes) may be displayed nonintrusively in the corner of the screen; or

4. Seamless embedded commercial—the commercial can be integrated into the programming virtually seamlessly—for instance an HRT system segment may be using downtown Chicago as its viewing locale or a cruise ship departing port. The Chicago city convention and tourism bureau and the cruise line are beneficiaries of the television exposure and may pay for additional or increased exposure.

In a first aspect of the present invention, the system 10 may provide a radio/television format that combines appropriate audio music and voice inputs with appropriate visual imagery for the purpose of creating an esthetically pleasing and relaxing experience.

In a second aspect of the present invention, the system 10 may provide a radio/television entertainment format whose purposeful design is to produce an effortless calmness and a therapeutic mental rest in the viewer's daily life.

In a third aspect of the present invention, the system 10 may provide a radio/television entertainment format that is non intrusive to the viewers attention and allows the viewer to conduct other activities such as reading or conversation.

In a fourth aspect of the present invention, the system 10 may provide a radio/television broadcast that is primarily live for maximum emotional connection, interest and therapeutic effect.

In a fifth aspect of the present invention, the system 10 may provide a radio/television entertainment production in which the scene can remain unchanged for minutes to hours at a time.

In a sixth aspect of the present invention, the system 10 may provide a radio/television entertainment format that allows the use of audio/visual, audio only, and visual only commercials.

In a seventh aspect of the present invention, the system 10 may provide a radio/television format that mixes live locale environmental sounds such as sounds of surf, running water, rain, thunder, fog horns, ships or locomotive engines into the program of music and interludes.

It will, of course, be understood that the foregoing description is of a preferred exemplary embodiment of the invention and that the invention is not limited to the specific embodiments shown. Other changes and modifications will become apparent to those skilled in the art and all such changes and modifications are intended to be within the scope of the present invention.

1. A hybrid audio and video system for providing video and/or audio to a display at a remote location in response to control signals received from a user, comprising:
at least one camera, located at a first location, for providing a first video feed of a subject at the first location;
a microphone, located at the first location for providing an audio feed of the first location;
a source of a second video feed;
a control node located at a central location and being coupled to the at least one camera, the microphone, and the second video source, the control node for receiving the control signals and providing a user video/audio feed to the display at the remote location based on the first video feed, the audio feed and/or the second video feed as a function of the control signals.

2. A hybrid radio and television system for providing video and/or audio to a display at a remote location in response to control signals received from a user, comprising:
at least one camera, located at a first location, for providing a first video feed of a subject at the first location;
a microphone, located at the first location for providing an audio feed of the first location;
a source of a second video feed;
a central studio being coupled to the at least one camera, the microphone, and the second video source, the control node for receiving the control signals and providing a user video/audio feed to the display at the remote location based on the first video feed, the audio feed and/or the second video feed as a function of the control signals.

3. A hybrid radio and television system, as set forth in claim 2, wherein the central studio combines the first video feed and/or the audio feed and/or the second video feed with appropriate visual imagery for the purpose of creating an esthetically pleasing and relaxing experience.

4. A hybrid radio and television system, as set forth in claim 2, wherein the central studio combines the first video feed and/or the audio feed and/or the second video feed to produce an effortless calmness and a therapeutic mental rest in the viewer's daily life.

5. A hybrid radio and television system, as set forth in claim 2, wherein the user video/audio feed is non intrusive to the viewers attention and allows the viewer to conduct other activities such as reading or conversation.

6. A hybrid radio and television system, as set forth in claim 2, wherein the user video/audio feed is primarily live for maximum emotional connection, interest and therapeutic effect.

7. A hybrid radio and television system, as set forth in claim 2, wherein the scene present by the user video/audio feed can remain unchanged for minutes to hours at a time.

8. A hybrid radio and television system, as set forth in claim 2, wherein user video/audio feed is one of audio/visual, audio only, and visual only commercials.

9. A hybrid radio and television system, as set forth in claim 2, wherein the user video/audio feed can mixes live locale environmental sounds such as sounds of surf, running water, rain, thunder, fog horns, ships or locomotive engines into the program of music and interludes.
